(19) United States
(12) Patent Application Publication
(10) Pub. No.: US 2026/0359999 A1
(43) Pub. Date: Nov. 12, 2026

(54) Dual-Function Depth Camera Array for Inline 3D Reconstruction of Complex Pipelines

(71) Applicant: NUtech Ventures, Lincoln, NE (US)

(72) Inventors: Zhigang Shen, Lincoln, NE (US); Zhexiong Shang, Lincoln, NE (US)

(73) Assignee: NUtech Ventures, Lincoln, NE (US)

(21) Appl. No.: 19/116,239

(22) PCT Filed: Oct. 4, 2023
(86) PCT No.: PCT/US2023/075985

§ 371 Date: Mar. 27, 2025

Related U.S. Application Data
(60) Provisional application No. 63/413,132, filed on Oct. 4, 2022.

(51) Int. Cl. G06T 7/579; G06T 7/593

(52) U.S. Cl. CPC G06T 7/579; G06T 7/596; G06T 2200/08; G06T 2207/10016

(57) ABSTRACT

A method for reconstruction a three-dimensional (3D) model of a pipeline and a system for implementing same where the method includes: acquiring data using a data acquisition module that controls streaming of red-green-blue-depth (RGBD) images from a forward-view camera and a plurality of oblique cameras, each camera disposed at a front of an inline rover, the forward-view camera facing forward, each oblique camera facing at least partially in a radially inward or outward direction toward a surface of the pipeline; estimating a pipe trajectory using a pipe trajectory estimation module that computes a route of the pipeline based on the RGBD sequence of images from a central camera; and mapping a pipe surface using a pipe surface mapping module that converts the estimated pipe routes into a complete, dense 3D surface map of the pipeline by incrementally merging the RGBD sequences from the each of the plurality of oblique cameras.

### CROSS-REFERENCE TO RELATED APPLICATIONS

This patent application claims the benefit of U.S. Provisional Patent Application No. 63/413,132, filed Oct. 4, 2022, which is incorporated in its entirety by reference and for all purposes.

### STATEMENT REGARDING FEDERALLY SPONSORED RESEARCH OR DEVELOPMENT

This invention was made with United States Government support under Grant Number 693JK31850013CAAP awarded by the U.S. Department of Transportation. The U.S. Government has certain rights in this invention.

### BACKGROUND

There are more than 2.6 million miles of natural gas pipelines in the US according to the National Transportation Statistics of the US Department of Transportation (DOT). Accurate and fast inspection methods need to be developed to ensure the safe operation of such large pipe networks. Autonomous inline inspection (ILI) tools, such as pipeline inspection gauges (PIGs) or robotic crawlers, are mostly used to periodically survey the pipelines. These in-pipe robots are usually equipped with non-destructive testing (NDT) sensors, such as optical, magnetic, electric, or acoustic sensors and methods, to detect inline defects while traveling inside the pipes. Due to the unavailability of Global Positioning System (GPS) signals within pipelines, the robot motions are continuously tracked, either using wheel encoders or inertial navigation systems (INSs), to record the pipeline trajectory of the pipeline (that is, the route/pathway along the centerline of a pipe) while locating the defects along the pipes.

### BRIEF SUMMARY

One or more aspects of the invention provides a method for reconstruction a three-dimensional (3D) model of a pipeline. The method includes: acquiring data using a data acquisition module that controls streaming of red-green-blue-depth (RGBD) images from a forward-view camera and a plurality of oblique cameras, each camera disposed at a front of an inline rover, the forward-view camera facing forward, each oblique camera facing at least partially in a radially inward or radially outward direction toward a surface of the pipeline; estimating a pipe trajectory using a pipe trajectory estimation module that computes a route of the pipeline based on the RGBD sequence of images from a central camera; and mapping a pipe surface using a pipe surface mapping module that converts the estimated pipe routes into a complete, dense 3D surface map of the pipeline by incrementally merging the RGBD sequences from the each of the plurality of oblique cameras.

### BRIEF DESCRIPTION OF THE DRAWINGS

FIGS. 1A and 1B depict front perspective and top views, respectively, of a DF-DCA system in accordance with the disclosure.

FIG. 1C present RGB images from each camera of the DF-DCA system in accordance with the disclosure.

FIGS. 2A and 2B illustrate pipe wall coverage of the central camera and an oblique camera, respectively, in accordance with the disclosure.

FIG. 3 presents a schematic view of a DF-DCA system in accordance with the disclosure.

FIGS. 4A and 4B compare inline image matching for a straight pipe section and a curved pipe section, respectively, in accordance with the disclosure.

FIG. 5 presents a flowchart for local map reconstruction in accordance with the disclosure.

FIG. 6 depicts a workflow of an incremental registration and fitting algorithm in accordance with the disclosure.

FIG. 7 presents a comparison of distance errors in accordance with the disclosure.

FIGS. 8A-8F provide various views of different portions of test pipes in accordance with the disclosure.

FIGS. 9A-9D compare full and detailed views of 3D reconstructions using different methods in accordance with the disclosure.

FIGS. 10A and 10B display 3D reconstructions using different methods in accordance with the disclosure.

FIGS. 11A and 11B provide detailed comparisons of 3D texture and texture-less maps in accordance with the disclosure.

FIGS. 12A and 12B provide comparisons of local map reconstruction in accordance with the disclosure.

FIGS. 13A-13E provide compare various views with ground truth in accordance with the disclosure.

FIGS. 14A-14C provide 2D views of geometric errors of pipe trajectories using different methods in accordance with the disclosure.

FIG. 15 presents 2D views of estimated pipe trajectory under different reference positions in accordance with the disclosure.

FIG. 16 presents laboratory results of the vSLAM method in accordance with the disclosure.

FIG. 17 presents a laboratory pipe wall with artificial pits and dents in accordance with the disclosure.

FIG. 18 presents a comparison of ground truth of defects and measurements of the defects in accordance with the disclosure.

### DETAILED DESCRIPTION

### 1. Introduction

When a camera is selected as the onboard sensor of an inline inspection tool, inline defects may be automatically detected and recognized using image processing and machine learning algorithms. A camera may also have the advantage of requiring minimal preparations of the pipework and may obtain three-dimensional (3D) models of the pipeline. Compared to two-dimensional (2D) images, 3D models contain geometric information that may better reflect the operating conditions of pipelines. These models may also support digital documentation of the pipes that are buried underground once assembled. In recent years, experiments with different technologies have been tried in an attempt to produce accurate 3D pipe models. Despite signs of progress, accurate 3D mapping of underground pipelines has remained a challenging task, especially for long and complex legacy pipelines where the actual trajectory of the pipe might be unknown and may contain multiple straight sections and/or bent sections with varying curvatures.

In robotics, the technique of tracking motion while building a map is known as simultaneous localization and mapping (SLAM). When a camera is used as the primary sensor, the technique is often named visual SLAM or vSLAM. In computer vision, vSLAM is often recognized as an alternative to structure-from-motion (SfM), which typically relies on visual odometry (VO) to build the model of the states and on graph optimization to estimate the best fit of the states by imposing additional constraints. Over the last decades, different vSLAM-based techniques have been developed to estimate the routes of pipes while reconstructing the internal walls of the pipes. Existing studies can be divided into two categories based on the number of cameras used: (1) pipeline mapping using a single monocular camera; (2) pipeline reconstruction using multi-camera vision systems.

### 1.1 Pipeline Mapping Using Single Monocular Camera

Inline inspection using monocular camera systems requires capturing multiple overlapped images to triangulate the depth information. A 3D map of the pipe may then be reconstructed by minimizing the reprojection errors between the overlapped images. To obtain the complete surface map at a single pass of the pipeline, a fisheye or omnidirectional lens may be selected as the onboard sensing system. For example, a forward-facing fisheye camera may be used to measure the shape of a sewer pipe. The in-pipe motions and the 3D pipe models may be computed through a hierarchy bundle adjustment (BA). Due to monocular systems being subject to scale ambiguity, prior knowledge of the pipe (e.g., diameter, shape, etc.) may be necessary for onboard camera calibration to remove outliers and recover the scale of the maps. The system may be improved by including weak geometric constraints into a sparse bundle adjustment (SBA) framework and obtaining accurate 3D appearance maps of complex pipe networks. The method may detect and map pipes containing straight and T-shaped sections by matching the shadows cast in the inline images to predefined templates. While this strategy may be able to survey pipelines containing different sections (e.g., straight, elbow, T-shapes, bent, etc.), the strategy is confined to certain camera and pipeline configurations, which limits the usage of this strategy in practice.

An SfM-based approach may also be used to unwrap and stitch the inline images into a 2D panorama map of a small-diameter bore pipe. Model fitting operation may be employed to correct noisy points from the SfM-generated point clouds. The method may be able to reconstruct bent/curved pipes by segmenting and fitting the point cloud at shorter segments.

Instead of performing SfM and fitting as two separate operations, the two operations may be fused into a unified procedure by imposing conic shape constraints into the BA optimization. The unified procedure was tested on pipes with different geometries, and the results showed that the reconstructed 3D maps contain less scale drift than the pure SfM and can better recover the routes of complex pipes without closed loops. However, like other monocular camera-based ILI systems, the method requires prior knowledge of the pipeline (e.g., diameter, shape, types of sections, etc.). Such information might not always be available, especially for legacy pipelines, or might not always be accurate for underground pipelines under the years of impact of geotechnical forces or excavation activities.

Methods have been presented that fused range sensors with the monocular camera system to resolve the scale-ambiguity problem of the monocular systems. A laser profiling technique is the most selected tool due to its high precision and invariance to shadow effects. By projecting a laser ring along the axial direction of the pipe through a conical mirror, the 3D shape of the pipe may be recovered by capturing the displacement of the laser contours in the image coordinates. A pipe profiling tool that reconstructs the interior shape of a pipe at submillimeter-level accuracy has been shown. A calibration method was used to minimize the misalignments between the camera and the profiler using a machine-fabricated calibration block. Further, a probe has been developed where the projected structure light contains multiple colored laser rings. This setup enables recovery of the profile of the pipe at each image capture and may be more robust against image misalignment. However, due to the sparsity of the laser rays, the technique has suffered slow speed during data collection. In addition, the probe often needs to be reconfigured/recalibrated when inspecting different pipes, making the laser-based technique inefficient for long-range, complex field measurements. More importantly, the technique requires the laser source to be centered to keep the rings shaped in circles, which is almost impossible for curved and elbow pipelines, as well as for imperfect pipes that have dents or deformations.

### 1.2 Pipelines Reconstruction Using Multi-Camera Vision Systems

A multi-camera system may commonly include two or more cameras observing a scene from different perspectives. When the baselines between the cameras are known, the depth measurement per pixel can be obtained using stereo triangulation. Compared to a monocular camera, a multi-camera system may generate dense surface maps of pipes without knowing the pipe geometry. A verged stereo system has been proposed to map the internal surface of a pipe. By pointing the stereo system toward one side of the pipe wall, the 3D shape of the internal surface of the pipe may be recovered using multi-view geometry. However, due to the limited field-of-view (FOV) of each camera, the system covers only part of the pipe. Full pipe interiors have been recovered using three tilted video cameras. Each 3D point on the pipe surface was reconstructed by maximizing the triple correlation coefficient of the pixel intensities from the cameras. A limitation of this method is that the method requires the system to be precisely positioned at the centerline of the pipe, which might not be applicable for field measurement.

To overcome this limitation, a geometric reconstruction and surface fitting algorithm for 3D reconstruction of pipes using a pair of side-by-side video cameras was developed. The method can be applied for 3D anomaly detection of both circular and oval-shaped pipes. However, the method was tested on only short pipe segments. Because the 3D information must be estimated at every pixel, this method is rather slow and requires heterogeneous texture across the pipe surfaces. These conditions might not be applicable for long and operating pipelines where the surface textures are sparse and repeated in shapes.

To overcome these limitations, a fast inline 3D reconstruction system using four non-centralized, oblique-viewed depth cameras has been developed. A depth camera array (DCA) calibration method to transfer the Red-Green-Blue plus Depth data (RGBD) image taken from each camera into a complete, unified, local surface map of the pipe was developed for this method. The local maps may then be registered into a global surface model of the pipe using RGBD odometry and pose graph optimization. However, the method requires a calibration pipe that might only work with straight pipelines with known pipe sizes (i.e., diameter) due to the standardization of the calibration space of each camera. Presently, fast, dense, and accurate 3D modeling of long and complex pipelines (i.e., pipes containing multiple arbitrarily curved segments) has remained a challenging task.

### 1.3 Objectives

The present disclosure overcomes the limitations of the existing technology in reconstructing longer and more complex pipelines that contain unknown curved segments. A dual-function depth camera array (DF-DCA)-based ILI system that may include a center-positioned depth camera for pipe trajectory estimation and four oblique-viewed depth cameras for dense surface mapping of pipelines. The 3D trajectory of the pipe may be estimated using a reference-assisted vSLAM framework followed by a newly developed subvolume-based approach for accurate 3D surface mapping of the pipelines. Compared to the single-camera-based ILI systems, this newly developed system may generate a 3D surface map of the pipeline at a higher level of completeness, density, and accuracy without the need of prior knowledge of the pipes. Compared to existing multi-camera inspection systems, the present disclosure does not require DCA calibration nor heterogeneous texture across the pipe walls, thus simplifying the ILI preparation for inspecting different pipelines. In addition, one or more embodiments requires as inputs neither the diameters nor the curvatures of the pipes, making the methods disclosed herein suitable for documenting both as-built and legacy pipelines.

One or more embodiments of the DF-DCA system disclosed herein may be calibration-free and may conduct the automated 3D reconstruction of pipelines with unknown sizes and curvatures in a single pass.

One or more embodiments of the DF-DCA system may achieve dense, complete, and accurate 3D pipe reconstructions through a subvolume-based multi-camera registration approach guided by a reference-assisted vSLAM framework.

One or more embodiments of the DF-DCA system may be at low cost and require the minimal knowledge of pipes (for example, size, types of sections, textures, etc.), which may be an effective tool to document legacy pipelines where most of the information on the pipes is missing or outdated.

### 2. System Design

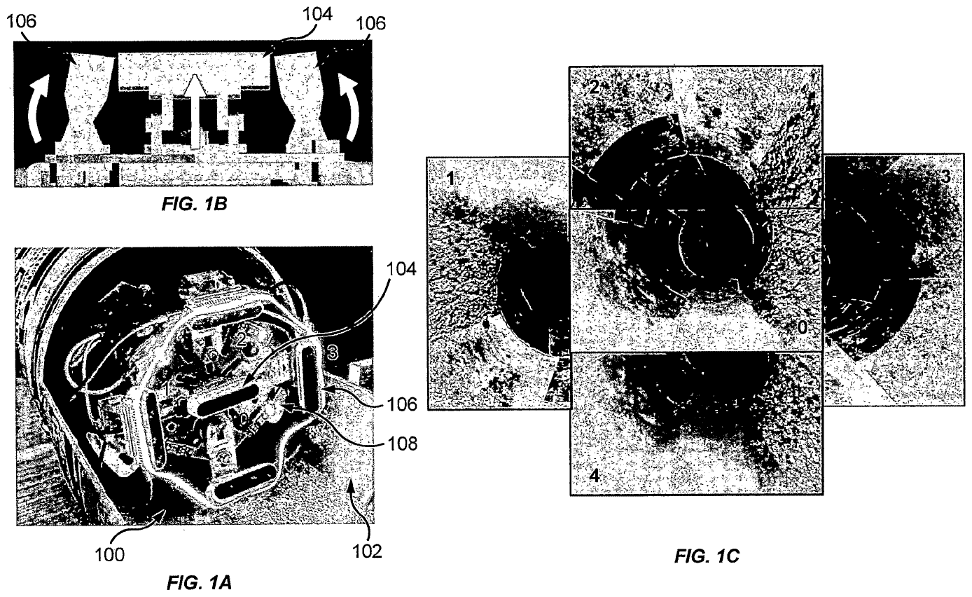

One or more embodiments of the DF-DCA ILI system may include a self-powered rover equipped with an onboard computer, lighting system, power supply, and proposed DF-DCA depth camera array. The DF-DCA may include five Intel RealSense (RS) D435 cameras mounted at the front end of the rover. In one or more embodiments, the layout of the DCA may include four symmetrically placed, oblique-viewed RS cameras and one center-positioned, forward-viewed RS camera. While RS cameras as used as non-limiting example, other cameras with similar capabilities may be used. The layout may include other numbers of cameras placed symmetrically or asymmetrically as well as a forward-viewed camera that is not center positioned. FIG. 1 shows a configuration of the DF-DCA system and the actual footage of each onboard RS camera. Note that this oblique angle (for example, approximately 35 degrees) may be dictated by the sizes of the pipes to acquire images with acceptable quality under the constraint of the minimal range requirement of the camera (for example, approximately 0.11 m for an RS camera). For example, in a larger pipe whose size may be far greater than the minimal-range constraint of the RS camera, the angle can be between 35 and 90 degrees. For even larger pipelines, the cameras may also be tilted outward instead of inward. The system may assume the pipes to be inspected are fixed-sized. Changing diameter pipelines may lead to challenges to the hardware development (for example, retractable arms, adaptive lightings and camera angles, etc.).

A front perspective view of embodiment of a DF-DCA system 100 in a cutaway pipeline (or pipe) 102 is presented in FIG. 1A. The DF-DCA system 100 as shown in FIG. 1A includes a forward-view camera 104 and a plurality of oblique camera 106. Each camera may be a depth camera. In one or more embodiments, the depth camera may be a RGBD camera. In FIG. 1A, there are four oblique cameras 106, but other numbers of oblique cameras may be employed. The forward-view camera 104 may also be referred to as a central camera, particularly when disposed approximately at the axis of the pipeline 102 as seen in FIG. 1A. The cameras 104, 106 may be disposed on a rover 108 that enables movement through the pipeline 102.

FIG. 1B provides a top view of the DF-DCA system 100. In particular, forward-view camera 104 is seen with an arrow indicating that the forward-view camera 104 can be rotated upward and downward. Oblique cameras 106 are provided with arrows to indicate that oblique cameras 106 can be rotated inward and outward.

FIG. 1C presents actual RGB images captured by the DF-DCA system 100 cameras 104, 106. The images are mirrored left/right with the cameras in FIG. 1A that captured the images.

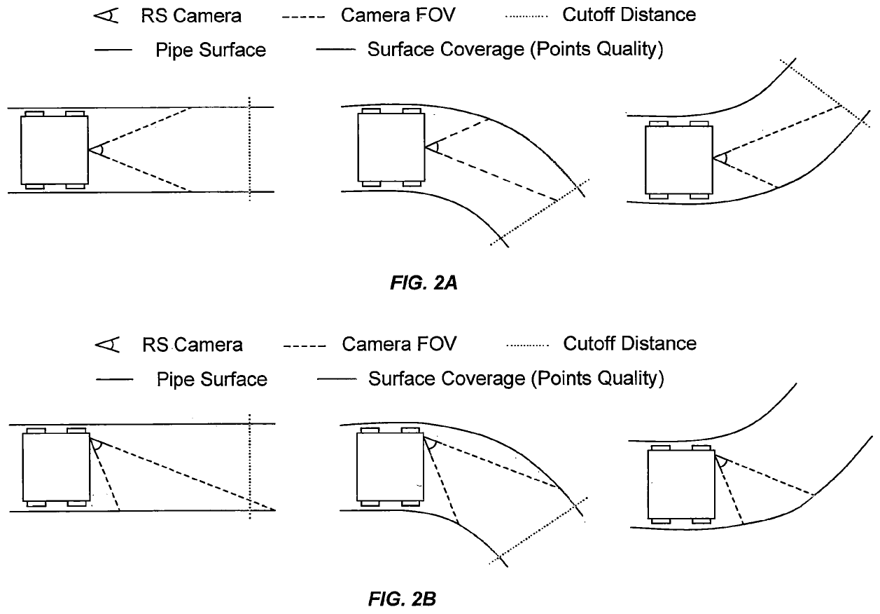

The RS cameras may rely on stereo infrared sensors and a customized semi-global matching algorithm to realize the depth measurement at each pixel. The camera may contain a laser projector that can emit invisible infrared (IR) patterns to support consistent depth measurement in low-light and poorly textured environments (for example, within pipelines). However, due to the depth information being estimated by the stereo triangulation technique, the point quality, which may include the accuracy and density of the projected 3D points, may be impaired as the distance increases. FIGS. 2A (top) and 2B (bottom) compare the surface coverage and 3D points quality of a central camera (FIG. 2A) and an oblique camera (FIG. 2B) in both straight and curved pipes. For the straight pipe, the central camera may provide a higher pipe coverage with lower quality than the oblique camera, which may cover only a part of the pipe wall. For the curved pipe, the central camera may cover only the external side of the pipe wall, while the oblique camera may cover the internal pipe walls when the pipe is oriented in the same direction. With four oblique cameras available, complete surface coverage and high point cloud quality may be ensured in both straight and curved pipes.

FIGS. 1A and 2B illustrate the pipe wall coverage and point quality (red regions denote pipe surfaces covered with higher quality points) of the central (FIG. 2A) and oblique (FIG. 2B) cameras at different pipe wall sections.

### 3. Methodology

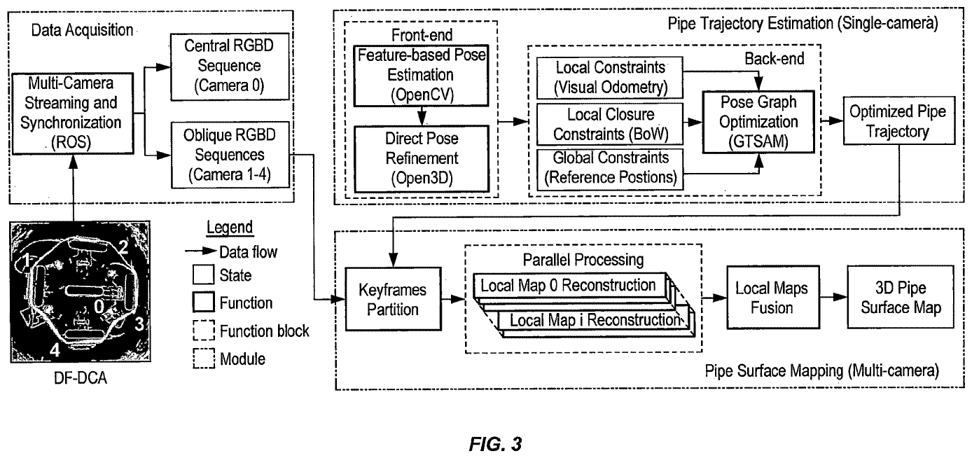

FIG. 3 provides an overview of a DF-DCA system according to one or more embodiments. The DF-DCA system may include three modules: (1) a data acquisition module, (2) a pipe trajectory estimation module, and (3) a pipe surface mapping module. The data acquisition module may control the streaming of each RS camera and synchronize the RGBD images from the different cameras. The pipe trajectory estimation module may compute the routes of the pipe based on the RGBD sequence from the central camera (Camera 0). The central camera may be selected due to the larger coverage at the pipe walls in both straight and curved sections than each oblique camera alone. The module may follow a typical single-camera-based vSLAM framework that may include a front-end and a back-end. The pipe surface mapping module may convert the estimated pipe routes into a complete, dense 3D surface map of the pipeline by incrementally merging the RGBD sequences from the oblique cameras (Cameras 1-4). In situations with noisy depth readings for each RS camera (for example, centimeter-level accuracy) and insufficient geometric features at the in-pipe conditions, the 3D maps obtained from different cameras may not converge into a unified pipe model due to the unknown bias and drift from each camera. Inspired by the subvolume-based technique, one or more embodiments of the method may divide the RGBD images into local partitions that may be less affected by the long-term drift errors while better preserving the shape of the pipe. The method may compute the pipe surface maps in three steps: 1) dividing the RGBD images into spatially coherent partitions; 2) reconstructing a local map of the pipe by registering the oblique RGBD images within each partition; and 3) fusing the partitioned local maps into a high-quality 3D global map of the pipe. Details of each module of the system are discussed in the following sections.

### 3.1 Data Acquisition Module

The data acquisition module may control the onboard RS cameras for concurrent camera streaming. In one or more embodiments, real-time data acquisition may be implemented in the Robotic Operating System (ROS). The RGBD sequence from each camera may be collected at a resolution of 848×480 with a frame rate at 60 hertz (Hz). Higher and lower resolutions and higher and lower frame rates may be selected as the operator desires and as equipment, software, and pipeline needs and other factors may require. ROS may also collect cycle time for each collected image, making it possible to synchronize different RS cameras. An ROS node may be created to subscribe to the image queue published from each camera and synchronize the images based on the timestamps in a soft way. The synchronization node may continuously pick the images queue from a base camera (e.g., Camera 0) and find the closest images from other cameras (e.g., Cameras 1-4) in real-time. The synchronization node may simultaneously publish the synchronized RGBD messages from different cameras until all images in the queue are passed. To further decrease the latency and increase the accuracy, both the I/O request of the camera and the synchronization procedure of the camera may be wrapped in a single ROS NodeletManager to take advantage of threading and less serialization overhead.

### 3.2 Pipe Trajectory Estimation Module

The pipe trajectory estimation module may use the RGBD sequence obtained from the central RS camera (i.e., Camera 0) to track the route of the camera as the rover passes through the pipe. The module may be developed based on typical vSLAM systems that can be divided into two function blocks: front-end and back-end. The front-end sequentially may track the camera poses between the images, whereas the back-end may optimize the estimated poses using pose graph optimization.

### 3.2.1 Front-End

The new SLAM front-end may estimate the in-pipe poses in a coarse-to-fine fashion: first, a feature-based pose estimation may be employed to initialize the pairwise transformations between the adjacent frames. An advantage of using the feature-based pose estimation method may be that the method can align images without initialization. However, camera poses estimated from feature matching might be inaccurate due to the sparse textures and low illumination conditions at the in-pipe environment. Thus, in the second step, the roughly aligned poses may be further refined using direct image alignment by maximizing the photo consistency measurements from all pixels in the images. Detailed steps of the feature-based pose estimation method and the direct image alignment method are discussed below.

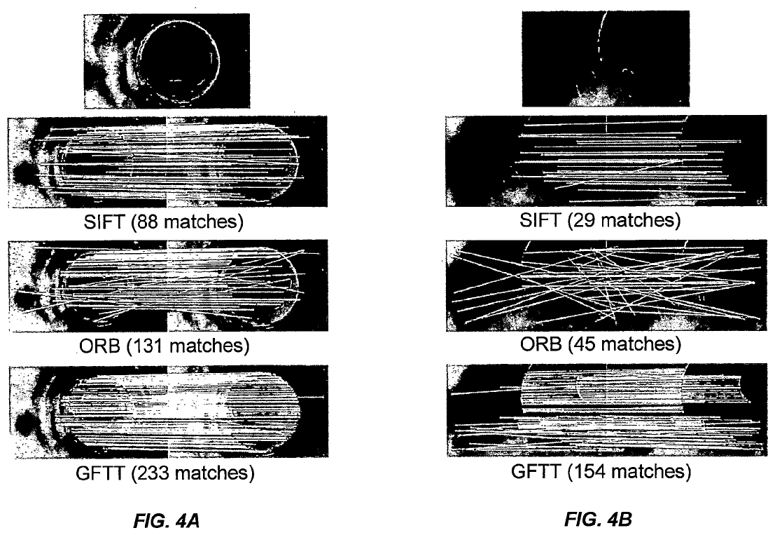

Feature-based Pose Estimation: For each RGBD image, the GoodFeaturesToTrack (GFTT) may be extracted from the color images to solve the correspondence problem due to the fast speed and the robustness to the low-illumination, texture-less conditions as opposed to other feature detectors/descriptors (e.g., Scale-Invariant Feature Transform (SIFT), Speeded Up Robust Features (SURF), Oriented FAST and Rotated BRIEF (ORB), etc.). FIGS. 4A and 4B compare the inline image matches using GFTT and other methods (i.e., SIFT and ORB). Clearly, GFTT finds most image matches in both the straight and the curved sections. GFTT may be more robust than other methods in regard to tracking failure in the inline environment. It is known that non-uniform feature extraction from a pipe wall can distort the motion estimation. Thus, the input image into 20×20 grids may be discretized with an upper limit of the number of features extracted within each grid. The depth image may be used as a mask to avoid extracting features at invalid depths. Image correspondences between the frames may be identified by the nearest neighbor distance ratio (NNDR) test using binary robust independent elementary features (BRIEF) descriptors. Due to the limited depth of view (DOV) of each in-pipe image and the single-pass of the environment, feature matching may be implemented with only the adjacent frames. For each pair of the matched frames, feature correspondences may be projected from the 2D image plane to the 3D space using depth information. The relative transformation may then be computed by optimizing the 3D-3D correspondences in a least-square formation. Random Sample Consensus (RANSAC) may be applied to reduce the outliers from mismatched points. An input image may be selected as a keyframe if there are sufficient correspondences with the prior keyframes and its distance/orientation to the nearest keyframe is larger than a threshold. Due to the single-pass condition at the in-pipe environment, only the most adjacent frames with the distance/orientation thresholds set as 0.1 meter/5 degrees, respectively, may be examined, though other threshold values may be used. This setup relates the number of keyframes to the traveled distance along the pipeline, avoiding redundant data collection and processing in the following steps.

Direct Pose Refinement: After the keyframes selection, the initial poses estimated from the sparse features may be further refined using dense RGBD alignment. The Colored-ICP algorithm may be employed, where ICP refers to Iterative Closest Point. The Colored-ICP algorithm may wrap the pixels from the current frame to the successive frame and find the rigid body transformations by minimizing a linearized energy function. The energy function may combine the geometric and photometric disparities at each pixel through a weighted sum formation. To ensure the registration converges to the global optima, multi-scale registration may be applied to convert the RGBD alignment into an iterative procedure. The direct pose method may output a sequence of poses that has lower projection errors than the feature-based method.

### 3.2.2 Back-End

Pairwise transformations between the keyframes might drift over a long distance. This may be most noticeable in the inline environment where a single misaligned frame can result in large errors in mapping the pipeline. Thus, a SLAM back-end may be needed to correct the accumulated drifts from the pairwise measurements.

The problem may be formulated as a bipartite factor graph with two types of nodes: the variables and the factors. The variables may represent the state estimates (e.g., poses), and the factors (i.e., constraints) may represent the sensor measurements or prior knowledge that constrains the variables. Three types of factors may be defined in the graph: local constraints, loop closure constraints, and global constraints. The local constraints may be defined via visual odometry, which may be computed based on the relative transformations between the adjacent keyframes. The loop closure constraints may be defined at the non-adjacent keyframes where there are sufficient correspondences between images. The potential loops may be detected using the visual bag of words (BoW) based on the GFTT features extracted at each keyframe. The global constraints may denote a set of reference points (also known as control points) with known positional measurements. In practice, many pipelines may contain the known segment lengths and/or GPS checkpoints. This information can be used as the global constraints to assist the correction of the accumulated drifts from the local measurements.

Based on the defined constraints, the problem of finding optimal state variables can be formulated as a maximum a posterior (MAP) inference problem (as in Eq. 1):

$${X}_{M A P} = {arg max}_{X} {\prod }_{i} {ϕ}_{i} ( {X}_{i}^{o} ) {\prod }_{j} {ϕ}_{j} ( {X}_{j}^{l} ) {\prod }_{k} {ϕ}_{k} ( {X}_{k}^{g} ) \qquad ( 1 )$$

where X⁰, X¹, and X^{g} are state variables associated with the local odometry constraints, the loop closure constraints, and the global reference position constraints, respectively. φ(⋅) is the Gaussian noise model where its negative logarithm is proportional to the error function associated with X. For local odometry constraints and loop closure constraints, the covariance matrix may be computed using the ICP-based linearization method. The noise model of the global constraints may be measured based on the precision of the positioning sensors (e.g., GPS). OpenCV and Open3D may be used to implement the SLAM front-end, and the Georgia Tech Smoothing and Mapping (GTSAM) framework may be used to solve the factor graph based on the Levenberg-Marquardt (LM) optimizer. The module may output the optimized poses at the keyframes that constitute a 3D trajectory of the pipeline.

### 3.3 Pipe Surface Mapping Module

The pipe surface mapping module may recover the 3D surface map of the pipeline using the synchronized RGBD sequences. 3D mapping using multiple depth cameras raises two issues: (1) finding the inter-camera transformations and (2) correcting the depth noise from each camera. While previous work relies on a calibration pipe with known size, one or more embodiments of the present disclosure may use a calibration-free method to directly register the depth cameras on inspecting pipelines. The calibration-free method may simultaneously deal with the depth noise and the accumulated drift from each camera while aligning the RGBD maps between different cameras. Due to insufficient textural/geometric features (e.g., 2D/3D corners, lines, shapes, etc.) at the in-pipe environment and the limited FOV of the onboard cameras, DCA registration using individual RGBD frames may not always converge to the global optimal. Thus, an embodiment of the present method may be developed based on a subvolume-based technique, which uses local maps/submaps (registered by a short image sequence) to increase the registration consistency while avoiding the accumulated drift from each camera. The method can be divided into three steps: first, separating the whole map of the pipe into spatially coherent partitions based on the selected keyframes; second, reconstructing the local maps/submaps within each partition by aligning the RGBD sequences from different cameras; third, fusing the reconstructed local maps between partitions into a global 3D map of the pipeline. Details of each step of the present pipe surface mapping module are discussed in the following sections.

### 3.3.1 Keyframes Partitioning

An embodiment of the disclosed method may define the partitions based on the timestamps at the keyframe poses from the estimated pipe trajectory. This setup may be suitable because only the temporally closed images are spatially adjacent at the in-pipe environment. Assuming the estimated trajectory containing K keyframes, each partition may be defined to contain l keyframes (l<K) and to set the overlapping ratio between adjacent partitions as λ. Thus, the map can be divided into N partitions as in Eq. 2 below:

$$N = ⌊ \frac{K - ( l - h )}{h} ⌋ h = l \cdot ( 1 - λ ) \qquad ( 2 )$$

where └⋅┘ is the floor function that ensures N is an integer and each partition contains the same number of keyframes. If K is not divisible, the reminders are integrated into the last partition. Due to the RGBD sequences from different cameras being synchronized and following the same timestamps, the RGBD images within each partition may also synchronized.

### 3.3.2 Local Map Reconstruction

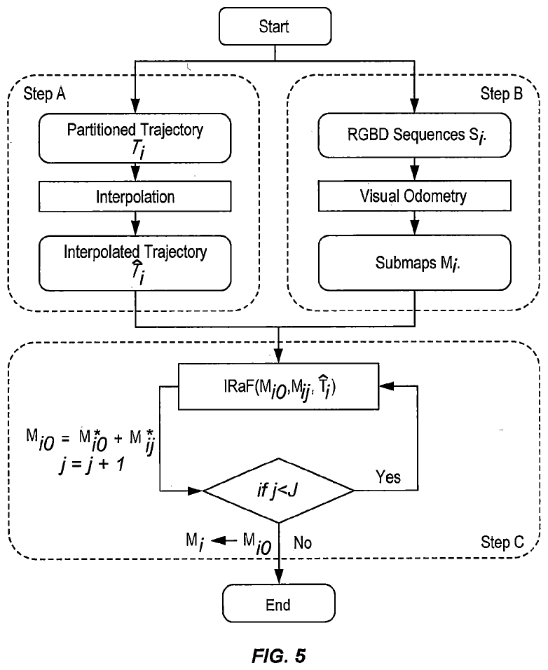

FIG. 5 shows a flowchart of the local map reconstruction according to one or more embodiments. For each partition i, the correspondent pipe trajectory is defined as Tᵢ and the RGBD sequences as Sᵢ. A local map Mᵢ(i∈N) of the pipe may then be reconstructed in three steps:

Step A. The poses in Tᵢ are interpolated to contain dense intermediate poses, denoted as \hat{T}ᵢ.

Step B. The submap of camera j, which is denoted as Mᵢⱼ(j=0, . . . , 4), is reconstructed using Sᵢⱼ based on the direct image alignment and the known pipe trajectory as in Section 3.2.1.

Step C. The submaps Mᵢ. may be recursively merged into a base submap. Due to the accumulated drift errors (from the pairwise image alignments) and the RGBD nonlinear depth distortion within each frame, the submaps may need to be registered non-rigidly. Thus, an incremental registration and fitting (IRaF) algorithm may be used to progressively remove both the long-term drifts and the short-term distortions while aligning the submaps between different cameras. The method may output a registered local surface map of the pipe Mt. The submap obtained from the central camera (Camera 0) may be used as the base submap (denoted as Mᵢ₀). This selection may be determined based on the condition that the central camera can better cover the 3D geometry of the pipeline than each oblique camera alone (as in FIG. 2). Thus, the submaps obtained from the central camera may be relied upon to provide the initial estimate of the pipe (i.e., diameter), which then guides the incremental alignments of the submaps from the oblique cameras. In the following, Steps A and C are discussed in greater detail.

### A. Trajectory Interpolation

To interpolate a partitioned pipe trajectory (i.e., a series of poses), one may first find the intermediate positions and then estimate the rotations. B-spline curve interpolation may be employed to compute the interpolated positions. The degree of the spline may be set to 3 such that the interpolated trajectory can follow the centerlines of both the straight and curved pipes. The smoothness factor may be set to 0 to tightly follow the input path. The density of the interpolation determines the smoothness of the interpolated trajectory and the computation needed for pipe surface mapping. In this study, we set the value as 1 centimeter (cm) to obtain a dense set of intermediate poses while keeping the computation load small. Based on the interpolated positions, the rotations may then be estimated using Inverse Distance Weighting (IDW). Due to the nonlinearity of the rotation matrices, matrix linearization may be needed. Thus, the rotation matrices may be converted into quaternions in the exponential spaces to linearize the variables. Due to the spline shape of the pipe routes, only the two preceding and the two subsequent poses are used to interpolate each rotation. Finally, the interpolated positions and rotations may be integrated into an interpolated trajectory with the density of poses much higher than the input.

### C. Incremental Registration and Fitting (IRaF)

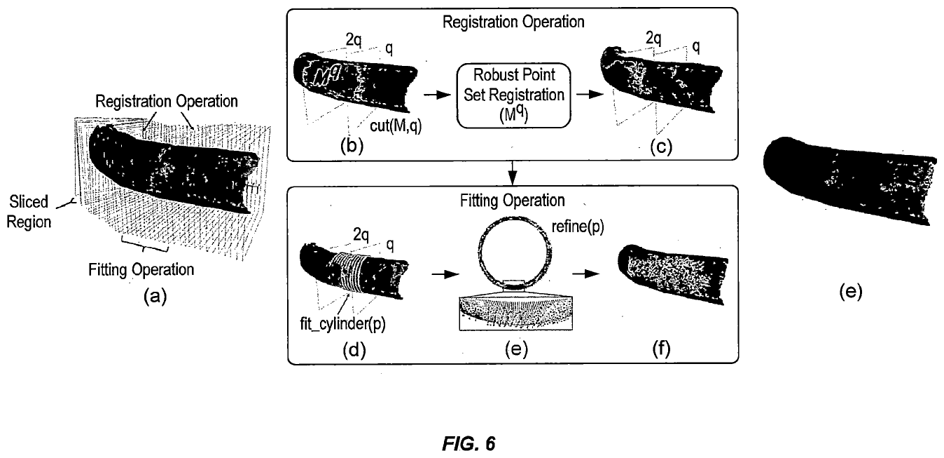

Given a pair of submaps, the IRaF algorithm of the present disclosure may incrementally perform the registration operations and the fitting operations at different frequencies (i.e., number of intermediate poses) to merge the aligning submap to the base submap. FIG. 6 shows the workflow of the presented algorithm. Specifically, the registration operation (cyan in (a) in FIG. 6) registers the non-refined submaps (i.e., partial submaps without performing the fitting operation) to initially merge the submaps along the direction of the pipe. After the registration operation, the fitting operation (orange in (a) of FIG. 6) may refine the submaps by densely slicing the submaps perpendicular to the pipe's direction and performing cylinder fitting operations within each sliced region, which may remove the distortions on the pipe surfaces. These two operations may be iteratively performed to gradually merge and fine tune the submaps along the trajectory of the pipe at different intervals. The colored submaps shown in (b) of FIG. 6 are an aligning submap (red) and a base submap (green) prior to registration at q. The colored maps after registration are seen in (c) of FIG. 6. In (d) of FIG. 6, the submaps are sliced and fitted. Referring to (e) in FIG. 6, the sliced submaps at p are corrected by the fitted cylinder where points with low distance errors are displayed in green, points to be refined in red, and points on the cylinder in yellow. The colored submaps after fitting operations are shown in (e) of FIG. 6. The output IRaF is shown at the right side of FIG. 6. In the following paragraphs, the two operations are denoted as: the high-frequency fitting loop and the low-frequency registration loop respectively, and both loops are discussed in greater detail.

High-frequency fitting loop: When the submaps are initially registered, the high-frequency fitting loop may densely slice and correct the submaps based on the locally fitted cylinders. This operation can be divided into three steps:

1) the submaps are sliced vertically at each intermediate pose (as in (a) in FIG. 6).

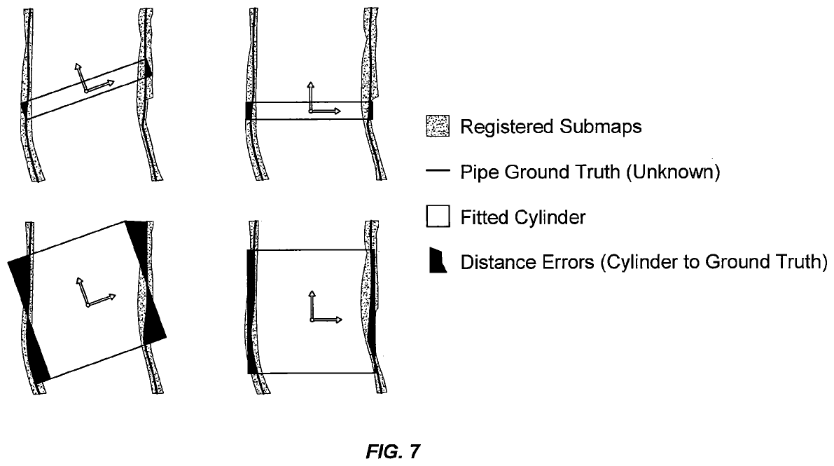

2) the fitting operation is then performed at each sliced region (as (e) in FIG. 6). The axial direction of the cylinder may be estimated by performing Principal Component Analysis (PCA) at the normal of the submaps. The normal of each point may be estimated using a least-square fitted plane based on nearest neighbors. This strategy can be directly applied to the submaps due to the smooth surface of the pipes. Next, the sliced points along the cylinder axis may be projected and estimate the center and radius of the projected points using hyper least square fitting. Due to the nonlinear depth noise of the RS camera and the non-perfect matching, the cylinder fitting may be wrapped into an iterative procedure using RANSAC. At each iteration, 10% of the points may be randomly selected for the fitting, and the remaining 90% may be used for the evaluation. Note that in this study, we set each sliced region as 2 cm long (with the intermediate poses set at every 1 cm) to provide sufficient overlapping between adjacent slices and, at the same time, keep each sliced region short for cylinder fitting such that the method can be adapted to reconstruct curved/elbow pipes. However, insufficient points along the cylinder axis may increase the difficulty of finding the true axial direction of the pipe. To overcome this challenge, a new error metric is introduced that increases the robustness of the cylinder fitting while keeping the sliced regions short. The basic idea is that the cylinders created with the corrected axial direction contain fewer errors than the incorrect ones as the cylinder length increase (as shown in FIG. 7). To accommodate for pipes with varied sections (e.g., straight, curved, elbow, etc.), multiple cylinders may be created with varying lengths and the fitting results evaluated based on the accumulated errors from each cylinder. Eq. 3 presents the new error metric:

$$e = \frac{{\sum }_{γ ∈ R} {w}_{γ} {D}_{γ + 1}}{\vert R \vert} {w}_{γ} = {( \frac{1}{2} )}^{γ} , D = M e d \{ d ( m , Ω ) \vert m ∈ M \} \qquad ( 3 )$$

where e is the new error metric, which may be computed as the weighted mean of the residues D between the locally fitted cylinders with different lengths and the sliced submaps. γ {γ=0, 1, . . . |γ∈R} denotes the index of the cylinders created. D_{γ+1} is the median of the shortest distance between each point m of the submap M and a locally fitted cylinder Ω with length along the axial direction of the cylinder multiple by γ+1. When γ=0, it denotes the length of the created cylinder equal to the sliced region. In this work, we set |R|=3, which makes the metric suitable for fitting both straight and curved/elbow pipe segments while reducing unnecessary computation (i.e., creating too many cylinders). w_{γ} is the coefficient that computes the weight of the errors measured from different cylinders. The weights may be reduced exponentially as the cylinder length deviates from the original one.

3) The last step is to refine the points on the sliced submaps based on the fitted cylinder. For each sliced submap, a KD-tree may be used to search for the nearest neighbors and measure the distance between each point from the submap to the cylinder. Based on the measured distances, the sliced submap may be refined based on Eq. 4 below:

$${M ( t )}^{*} = \{ \begin{matrix}M ( t ) if d ( t , Ω ) < {χ}_{1} \\ Ω ( t ) if d ( t , Ω ) \geq {χ}_{1} and d ( t , Ω ) < {χ}_{2} \\ ∅ Otherwise\end{matrix} \qquad ( 4 )$$

where M(t) and M(t)* respectively indicates the tth point in the input and the refined submap. χ₁ and χ₂ are user defined distance thresholds that define the lower and upper bounds of the points to be corrected. These parameters ensure that the method refines only the points at close distances while rejecting the outliers (d>χ₂) in the result map. By keeping the points with low distance errors (d<χ₁), the method may also preserve the geometry at the internals of the pipeline for anomaly detection. In this study, we set χ₁=0.5 cm to reflect the millimeter-level defects (e.g., pitting, dents, deformation, etc.), and let χ₂=2 cm based on the raw depth precision of the RS camera. By incrementally refining the sliced submaps at each intermediate pose, the method may output the refined submaps with minimized local depth errors. Algorithm 1 shows the pseudocode of the new high-frequency fitting loop.

FIG. 2 presents a comparison of the distance errors between the incorrect (left) and correct (right) fitted cylinders with varying lengths. At the top, the cylinder length is equal to the sliced region. At the bottom, the cylinder length is significantly longer than the sliced region.

Algorithm 1 Pseudocode of the high-frequency fitting loop

| | |
|---|---|
| 01: Input: M, T | |
| 02: set: M* ← Ø | |
| 03: for every pose p in T do | |
| 04: set: e ← ∞, Ω ← Ø | |
| 05: Mₚ, Nₚ < slice(M, p) | % Slicing Operation |
| 06: for [symbol] ← 1 to [symbol] do | % Fitting Operation |
| $07 : random {M}_{p}^{0.1} , {M}_{p}^{0.9}$ | |
| $08 : {Ω}_{\text{?}} ← fit\_cylinder ( {M}_{p}^{0.1} , p , r )$ | |
| $09 : {e}_{\text{?}} ← error ( {M}_{p}^{0.9} , {Ω}_{\text{?}} )$ | % Error Metric (Eq. 3) |
| 10: if e; < e do | |
| 11: e ← [symbol] | |
| 12: Ω ← [symbol] | |
| 13: end if | |
| 14: end for | |
| $15 : {M}_{p}^{*} ← refine ( {M}_{p} , Ω )$ | % Submap Refinement (Eq. 4) |
| $16 : {M}^{*} ← {M}^{*} + {M}_{p}^{*}$ | |
| 17: end for | |
| 18: Output: M* | |

Low-frequency registration loop: At every k intermediate poses, the low-frequency registration loop may cut off the refined submaps (if not empty) along the trajectory of the pipes and may register the remaining submaps through rigid body transformations (as the registration operation in (b) and (c) of FIG. 6), which progressively removes the accumulated drifts caused by the pairwise image alignment from each camera. For each pair of the remaining submaps, a robust point set registration method may be applied to iteratively filter out the erroneous points while finding the transformation where the registration error is minimized. The method may be achieved by finding the correspondences based on an adaptively determined distance threshold. Eq. 5 shows the equations of the thresholding, which analyzes the statistic of the Euclidean distances between the correspondences at each iteration.

$$η = \{ \begin{matrix}μ + 3 σ if μ < η \\ μ + 2 σ if μ \geq η and {μ}_{d} < 3 η \\ μ + σ if μ \geq 3 η and {μ}_{d} < 6 η \\ η Otherwise\end{matrix} \qquad ( 5 )$$

where μ and σ are the mean and standard deviation of the distances between the correspondences (C), and ij is the distance threshold. The η may be set as a large value to initiate the iterations and trim the submaps. In this study, we set η=5 cm for fast convergence. Colored-ICP may be employed to align the submaps based on both geometric and textural information. The iterations may continue until the error is minimized while the size of the correspondence set (f) is maximized. The registered submaps may then be used as the input for the high-frequency fitting operation until every intermediate pose is visited. Algorithm 2 summarizes the pseudocode of the new low-frequency registration loop.

Algorithm 2 Pseudocode of the low-frequency registration loop

01: Input: Mₐ, M_{b}, T
$02 : initialize : {M}_{a}^{*} ← ∅$
03: for every k poses q in T do
04: set: η, e ← ∞, f ← 0, t_{q} + I₄

| | |
|---|---|
| $05 : {M}_{a}^{q} , {M}_{b}^{q} ← cut ( {M}_{a} , {M}_{b} , q )$ | % Cut Off Submaps |
| 06: for [symbol] ← 1 to [symbol] do | % Registration Operation |

$07 : {C}_{a}^{q} , {C}_{b}^{q} , {t}_{\text{?}} , {e}_{\text{?}} , {f}_{\text{?}} ← colored\_icp ( {M}_{a}^{q} , {M}_{b}^{q} , η )$
08: if [symbol] < e and [symbol] > f do
09: e ← [symbol] , f ← [symbol] , t_{q} ← [symbol]
10: end if
$11 : η ← threshold ( {C}_{a}^{q} , {C}_{b}^{q} , η )$
$12 : {M}_{a}^{q} , {M}_{b}^{q} ← trim\_submaps ( {M}_{a}^{q} , {M}_{b}^{q} , η )$
13: end for
$14 : {M}_{a}^{q} ← transform ( {t}_{q} , {M}_{a} )$
$15 : {M}_{a}^{*} ← {M}_{a}^{*} + {M}_{a}^{q}$
16: end for
$17 : Output : {M}_{a}^{*}$

### 3.3.3 Local Maps Fusion

After the submaps within each partition are registered into a local surface map, these local surface maps may be transferred back to the global coordinate system and fused into a 3D global map of the pipeline. Due to the adjacent partitions being overlapped, it is possible that the overlapped regions may not be perfectly aligned. Thus, the high-frequency fitting loop may be performed at every overlapped region to correct the imperfect alignments. Finally, moving least square (MLS) may be employed to smooth the surface of the map. The output may be a smoothed 3D reconstruction of the pipeline that recovers both the 3D trajectory and the surface textures at the internals of the pipe.

### 4. Experiments and Results

### 4.1 Experimental Setup

### 4.1.1. Pipeline Selection

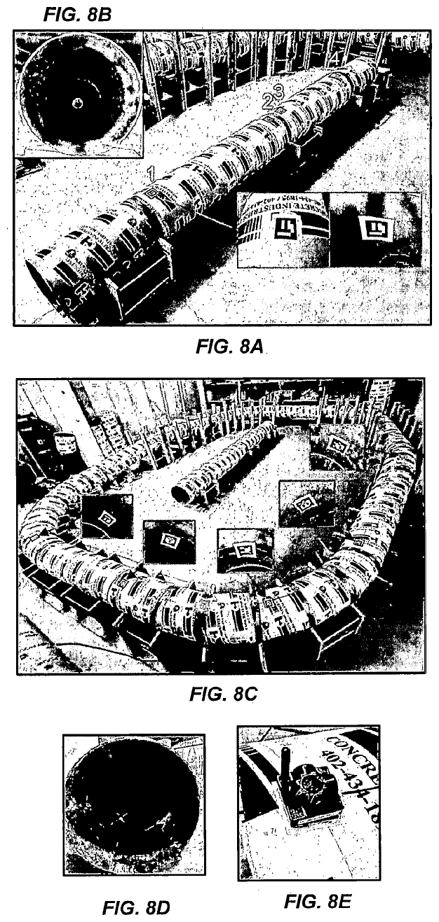

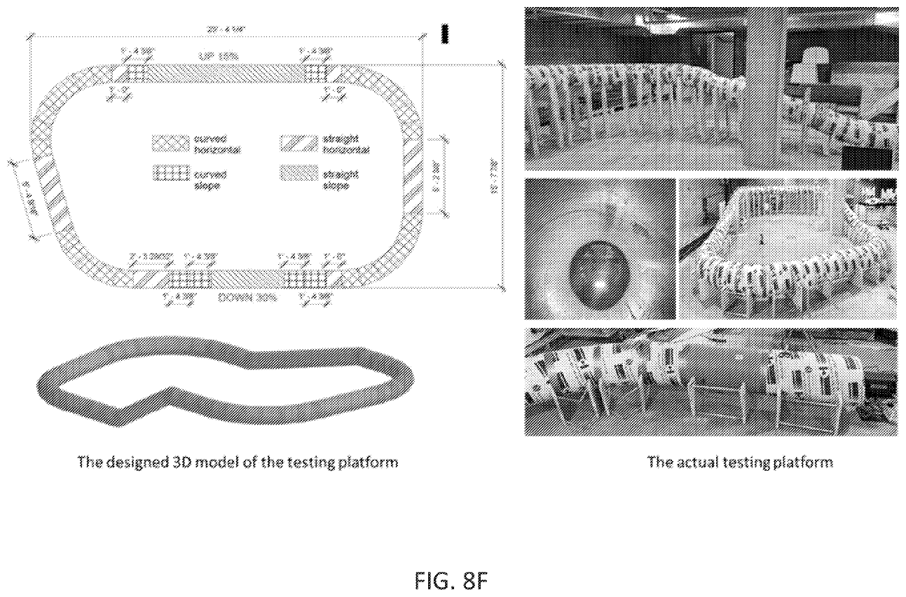

Real-world underground pipelines may run across sophisticated terrains such as mountains and riverbeds. As a result, the pipelines may curve in three dimensions instead of just in two dimensions. The design of the lab experimental pipes needs to consider the field reality and contain curved sections in three-dimensional spaces. In this study, we performed experiments with our system on two shapes of test beds made of 14-inch (36-cm) diameter pipelines: (1) a 9-foot (2.7-m) long straight pipeline and (FIG. 8A) (2) an approximately 70-foot (21-m) long pipe loop with straight, curved, and elbow sections in different planes (FIG. 8C). All laboratory pipelines are made of sections of rigid cardboard pipes. The size of each pipe section is known. For the straight pipe, artificial random textures were created by spraying paint on the internal pipe walls (FIG. 8B). For the pipe loop, both the random textures and the images of real-world pipes are printed and attached to imitate the texture of the operating pipelines (FIG. 8D).

### 4.1.2 Reference Points

ArUco markers (5×5 cm) with the same ids are attached at both the external and the internal of the pipes, in lieu of reference points of real pipelines with GPS points. For the straight pipeline, four markers are attached along the pipe's axial direction (as highlighted in FIG. 8A). For the complex pipe loop, fifteen markers are uniformly distributed along the pipe's route. FIG. 8C shows five of the fifteen markers attached at both sides of the pipe loop. In this study, the absolute positions of the markers are measured by Marvelmind precise indoor positioning system. The system can achieve ±2 cm precision in an indoor environment which is close to the precision of the off-the-shelf real time kinematics (RTK) GPS receiver in the real-world environment. For each externally attached marker, the position of the external marker may be measured by placing a Marvelmind Super-beacon at the center position of the marker (as in FIG. 8E). The markers attached to the inside of pipes can then be measured by subtracting the pipe thickness along the normal of the marker. To correct the estimated trajectories of the pipes using the reference points, the markers need to be detected and located by the inline images. To achieve that, we first detect the markers within each keyframe image. Next, we transform the marker centers estimated at the image space to the pipeline space based on the estimated poses. The translations between the indoor GPS measured marker centers and the inline images' estimation can then be found. These translations may be used to obtain the real positions of the VO estimated poses, which are then imported as the reference nodes in GTSAM for pose graph optimization and trajectory correction. FIG. 8F provides a map, a 3D model, and photographs of one test facility according to the present disclosure.

### 4.1.3 Baseline Methods

In prior works, vSLAM systems have been employed for the trajectory estimation and surface mapping of the pipes. Thus, a generic vSLAM method needs to be considered as the baseline. In this study, we selected the RTAB-Map due to the ROS compatibility of the RTAB-Map and the ability to reconstruct dense surface maps. RTAB-Map is an open-source, appearance-based vSLAM system. It takes the RGBD images as input and computes the visual odometry using a sparse feature-based method. The estimated camera poses may then be corrected through loop closure detection with a memory management mechanism to ensure real-time performance for mapping large-scale scenes. Similar to our method, RTAB-MAP uses pure pose graph optimization as the SLAM backend. Thus, the two methods are comparable when the same feature detection/matching strategies and the graph solver are selected. Similar to most RGBD SLAM frameworks, RTAB-Map does not inherently support importing reference points, thus only the visual odometry and loop closure nodes may be defined for the graph optimization. In addition, RTAB-Map is a single-camera based SLAM, thus only the central RS camera is used in the system.

The method presented in prior work of the inventors (denoted as the calibration method in the following paragraphs) is selected as an additional baseline method for the straight pipe segment. One or more embodiments of the present disclosure calibrate four oblique RGBD cameras (Camera 1-4) based on the same-diameter pipeline. The method may generate a dense and complete surface map of the pipe at a single pass based on the RGBD odometry estimated by the direct dense method. This surface map may be used as the ground truth to evaluate the 3D reconstruction quality of the presented approach where the onboard DCA are uncalibrated.

### 4.2 Results

### 4.2.1 Straight Pipe Segment

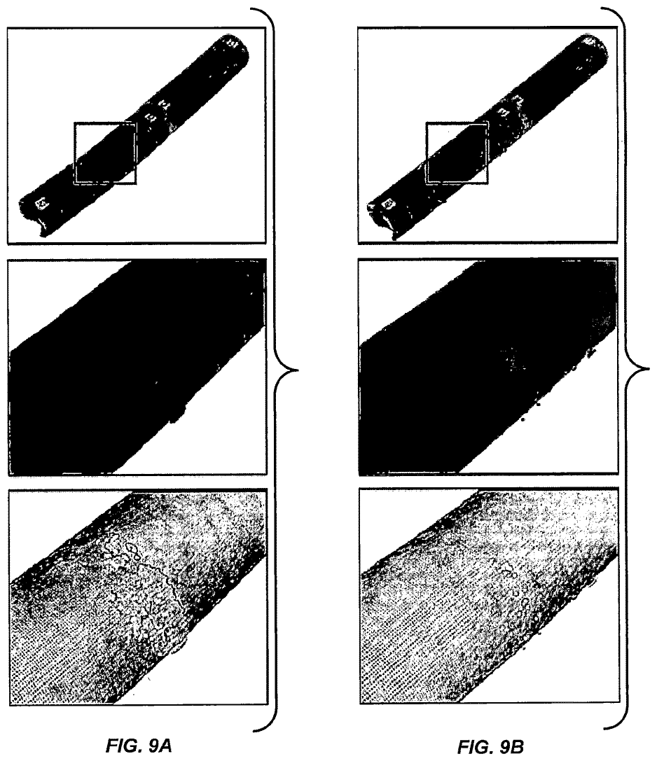

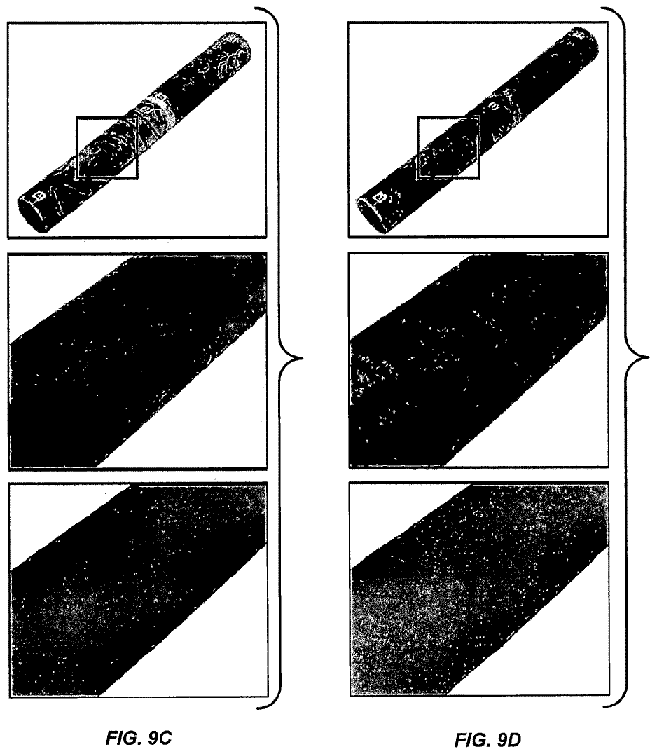

FIGS. 9A-9D compare the full and detailed views of the 3D surface maps of the straight pipe segment estimated using different methods: (FIG. 9A) RTAB-Map based on the central camera (Camera 0); (FIG. 9B) the new method with central camera; (FIG. 9C) the calibration method based on four oblique cameras (Cameras 1-4); and (FIG. 9D) the new method using five RS cameras (Cameras 0-4). For the single-camera-based methods (FIGS. 9A and 9B), the pipeline recovered from RTAB-Map (as in FIG. 9A) misaligns at the highlighted region. In contrast, the new method, which combines the feature-based and the direct measurement approach, generates better results (as detailed in FIG. 9B). However, discontinuities are still observable from the reconstructed pipes due to the higher noise level of the depth readings from the central RS camera (as discussed in Section 2.1). For the multi-camera based methods (FIGS. 9C and 9D), the 3D pipe reconstructed from the calibration method shows the best performance in terms of textural smoothness and geometric accuracy (as in FIG. 9C). The issue of missing points in the single-camera-based methods is eliminated. The 3D reconstruction of the straight pipe recovered using the new method (as in FIG. 9D) shows comparable results to the calibrated one both photometrically and geometrically without the need of the DCA calibration.

Quantitative evaluation on the geometric accuracy of the models includes two aspects: the accuracy along the cross section of the pipe and the axial direction of the pipe. For the first case, we evaluate the errors between the estimated pipe radius and the known dimension of the pipe. In this study, cylinder fitting is employed to estimate the radiuses of the reconstructed pipes along the axial direction. The means and standard deviations are then used to evaluate the reconstruction accuracy of different methods. Unlike the calibration method where the diameters of the pipe are utilized as the input for the distortion correction, both RTAB-Map and the new method directly relies on the RS cameras to sense the size of the pipe. It is worth noting that RS cameras inherently have approximately a 2 to 5 millimeter offset for depth sensing at close distances (up to 1 meter), which can distort the measured pipe diameter. Thus, in this study, the central RS camera was calibrated to remove such bias. Table 1 presents the statistics of the estimated radiuses and the comparisons with the ground truth. Clearly, our method shows approximately 20% decrease of the mean error and 40% reduction of the standard deviation than RTAB-Map where only the central camera is used for pipe reconstruction. For the multi-camera test cases, compared to the calibrated one, the new method presents the only 10% increase of the mean error while showing more than 50% less standard deviation due to the locally imposed cylinder constraints on the inspected pipeline. The results demonstrate the effectiveness of the new method in reconstructing pipelines with unknown pipe sizes.

For the evaluation of the accuracy of the model along the pipes, the estimated marker-to-marker distances may be compared to the ground truth. In this study, the ground truth is obtained by a laser distance measurer. Table 2 compares the measured marker-to-marker distance errors of different methods. Due to RTAB-Map relying only on sparse features captured from the central camera, RTAB-Map presents the worst results, with a distance error of 1.1% in the best-case-scenario. By incorporating the direct dense method and fusing the images from the oblique camera, the distance errors in the calibration method can be reduced to 0.54%. In contrast, the new method employs the reference points to correct the poses estimated from the pairwise measurements. The distance error is reduced within the range of 0.1%-0.3%, which outperforms both single-camera-based and multi-camera-based methods.

The full and the detailed views of the 3D reconstruction using (a) RTAB-Map (Camera 0) in FIG. 9A; (b) ours (Camera 0) in FIG. 9B; (c) the calibration method (Cameras 1-4) in FIG. 9C. (d) ours (Cameras 0-4) in FIG. 9D. The top row shows full views of the 3D map with a highlighted region. The middle row shows detailed views of the highlighted region. The bottom row shows detailed views of the highlighted region without surface textures.

TABLE 1
Statistics of the estimated radius and the errors to the ground
truth measurements of the straight pipe (units in millimeters)

| | Ground | Measured | Measured errors | |
|---|---|---|---|---|
| | truth | radius | | Standard |
| Methods | radius | (Median) | Mean | deviation |
| RTAB-Map | 175.8 | 176.9 | 1.279 | 0.742 |
| (Camera 0) | | | | |
| Ours | | 176.8 | 0.992 | 0.305 |
| (Camera 0) | | | | |
| Calibration | | 174.9 | 0.855 | 0.107 |
| (Cameras 1-4) | | | | |
| Ours | | 176.7 | 0.986 | 0.051 |
| (Cameras 0-4) | | | | |

TABLE 2
Comparison of the markers-to-markers distance (Lᵢⱼ denotes
the distance between the centers of marker i and j as highlighted
in FIG. 8A) of the straight pipe

| | L₁₂ | | | L₃₄ | | | L₁₄ | | |
|---|---|---|---|---|---|---|---|---|---|
| | Distance | Error | | Distance | Error | | Distance | Error | |
| Methods | (mm) | (mm) | (%) | (mm) | (mm) | (%) | (mm) | (mm) | (%) |
| Ground Truth | 1379 | \ | \ | 1068 | \ | \ | 2595 | \ | \ |
| RTAB-Map | 1315 | 64 | 4.64 | 1056 | 12 | 1.12 | 2528 | 57 | 2.58 |
| Calibration | 1351 | 28 | 2.03 | 1076 | 8 | 0.75 | 2579 | 14 | 0.54 |
| Ours | 1376 | 3 | 0.22 | 1067 | 1 | 0.09 | 2601 | 6 | 0.23 |

### 4.2.2 Pipe Loop

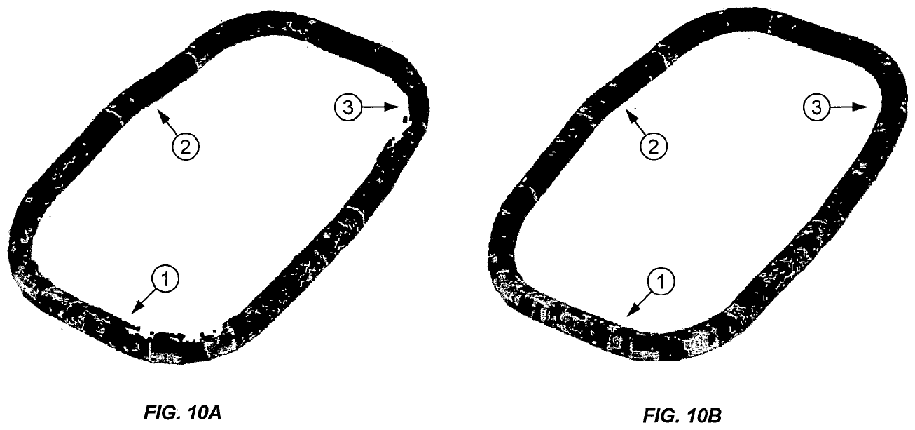

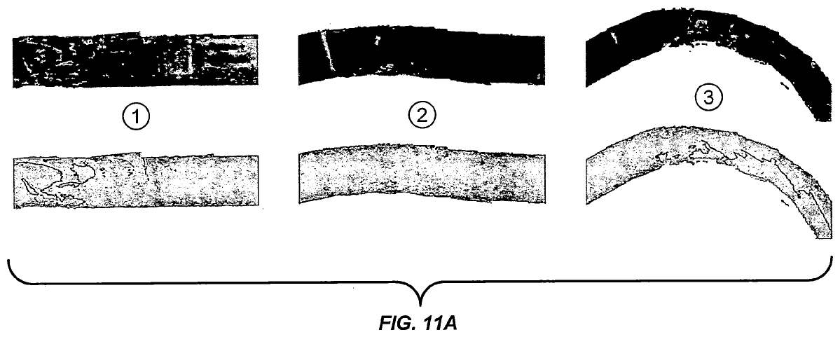

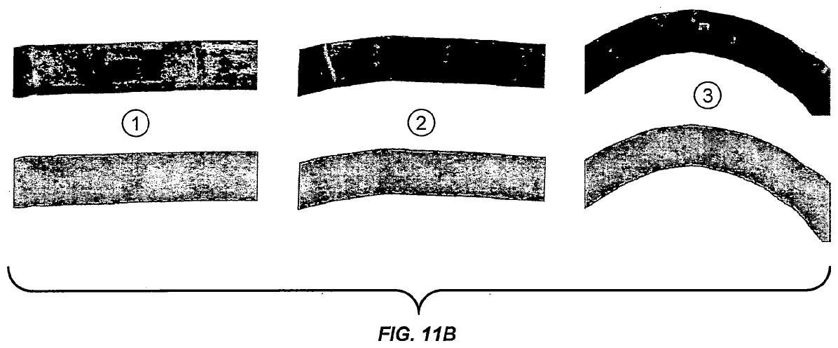

FIGS. 10A and 10B show the 3D reconstruction of the pipe loop using RTAB-Map (with Camera 0) and the new method (with five cameras), respectively. Compared to one or more embodiments of the presented method, which provides the complete surface coverage at the pipe walls, RTAB-Map fails to recover the inner side at the elbow and curved sections due to the limited camera FOV (as demonstrated in FIG. 2). Three challenging regions are highlighted for the in-depth comparison: The first region is a straight pipe next to a curve section. The region has rich textures that can be used for the detailed comparison of the surface maps. The second region is located at the downhill part of the loop. The rover passes this region at a relatively high speed with fast changes in the image contents. The third region is an elbow pipe, and this region is challenging for pipe fitting due to the significant orientation changes along the pipe's centerline. FIG. 11 shows the detailed comparisons at these three regions. Clearly, the new method outperforms the RTAB-Map both in texture smoothness and geometrical completeness, especially at the elbow sections.

FIGS. 3A and 11B provide detailed comparisons of 3D texture and texture-less maps using (a) RTAB-Map and (b) ours at the highlighted regions, respectively.

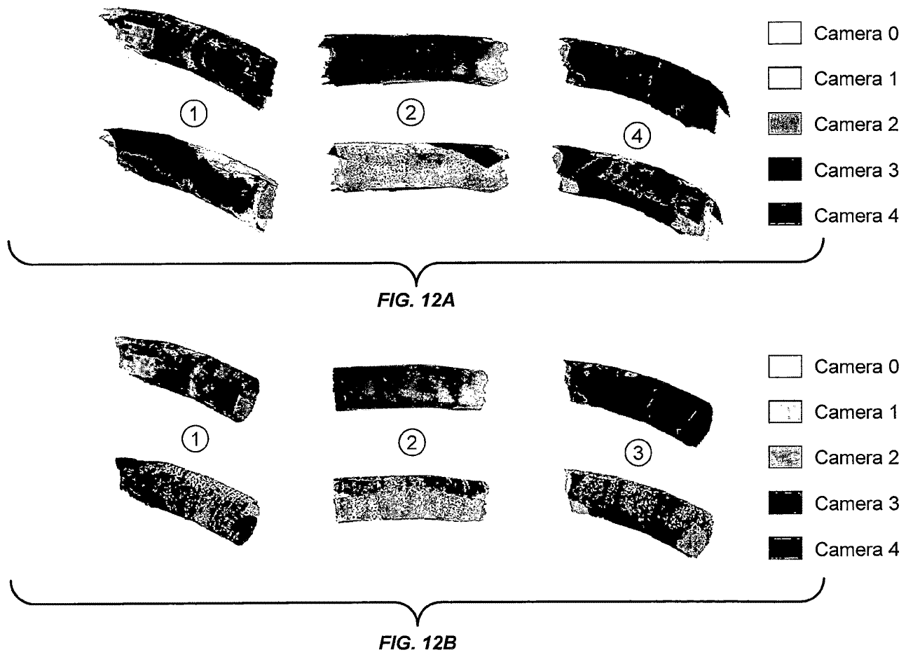

The accuracy of the 3D reconstruction of the new method is attributed to the presented IRaF algorithm which fuses the submaps from different RS cameras (as discussed in Section 3.3.2). FIGS. 12A and 12B compare the registered local maps at the three selected regions using the new IRaF algorithm (in FIG. 12B) and Colored-ICP (in FIG. 12A). The texture and the color-coded maps demonstrate that the new IRaF algorithm can better align submaps from different cameras while adaptively removing the noisy points on both sides of maps that might cause Colored-ICP to be trapped at local optimum. Table 3 shows the quantitative evaluation of the registration. Two indicators are used in the assessment: overlap ratio and root mean square error (RMSE). For a pair of point clouds, the overlap ratio estimates the percentage of the points from the source cloud to its correspondent points in the target cloud where the distance is less than a pre-defined threshold. The RMSE, on the other hand, measures the shortest distance between the correspondences. In this study, we set the distance threshold as 5 millimeter (mm) and compute the means of the overlap ratio and the RMSE between each pair of the submaps. The results showed that the new IRaF algorithm approximately increases 40% of overlap ratio while reducing more than 50% of the RMSE when compared to Colored-ICP.

TABLE 3
Evaluation of the submaps registration using
Colored-ICP and IRaF at the three highlighted regions.

| | R₁ | | R₂ | | R₃ | |
|---|---|---|---|---|---|---|
| | Overlap | | Overlap | | Overlap | |
| | Ratio | RMSE | Ratio | RMSE | Ratio | RMSE |
| | (%) | (mm) | (%) | (mm) | (%) | (mm) |
| Colored-ICP | 30.8 | 2.9 | 24.6 | 2.8 | 32.9 | 2.9 |
| IRaF | 56.7 | 1.3 | 44.3 | 1.4 | 52.0 | 1.3 |

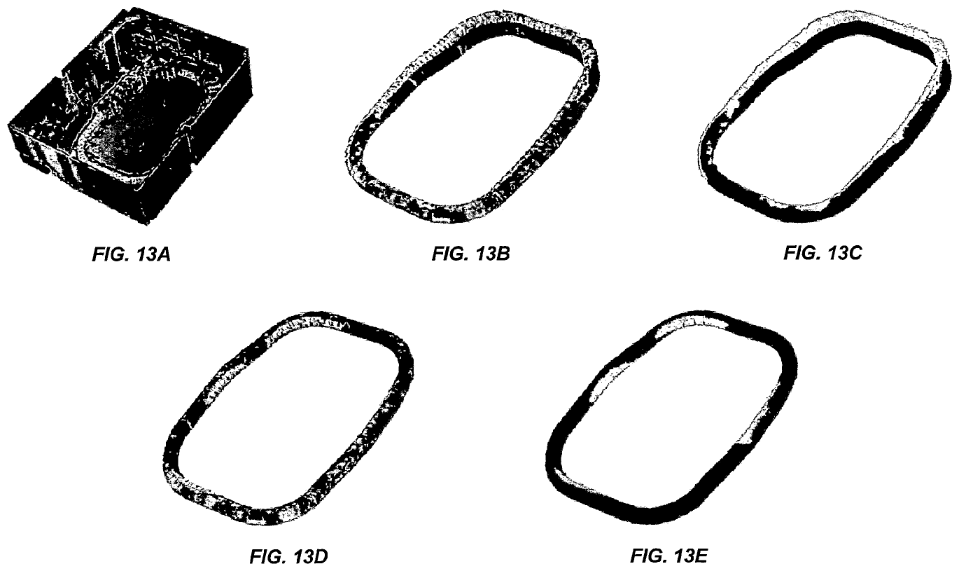

To evaluate the geometric accuracy of the reconstructed pipe loops, the 3D models may be compared with the ground truth. In this study, the ground truth model of the loop may be obtained using terrestrial laser scanning (TLS). Leica BLK360 was selected as the scanner because of its small size and millimeter-level accuracy at a close distance. Due to the inaccessibility of the internal surfaces of the pipe after the assembly, the scanned model only covers the externals of the pipe. FIG. 13A shows the TLS scanned point cloud model of the pipe loop. To make a proper comparison, we manually crop the pipe loop out from the original point cloud and overlay it onto the inline reconstructions. FIGS. 13B-13E, respectively, show the overlap of the ground truth onto the inline reconstructions based on RTAB-Map and the new method. The color-coded results demonstrate that our method can better recover the 3D geometry of the pipes due to the less deviations to the TLS results. However, the results still demonstrate that there are mismatches between the models, especially at the curved sections where the orientations of the camera change significantly.

FIG. 13A presents the ground truth obtained using a laser scanner; FIG. 13B provides overlapped views of the ground truth and RTAB-Map in original texture; FIG. 13C provides overlapped views of the ground truth (yellow) and RTAB-Map (red) with color coding; FIG. 13D shows overlapped views of the ground truth and ours in original texture; and FIG. 13E presents overlapped views of the ground truth (yellow) and ours (red) with color coding.

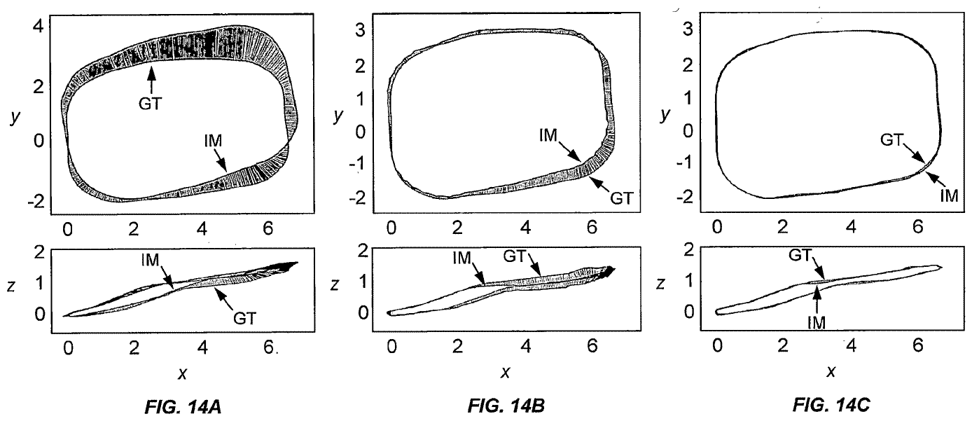

To quantitatively evaluate the 3D geometric accuracy, the trajectories (i.e., centerlines) of the pipe may be extracted from both the inline reconstructions and the ground truth. The geometric accuracy can then be measured by computing the Euclidean distance between each pose on the estimated pipe trajectory and the ground truth. FIGS. 14A-14C show 2D plots of the geometric errors (red) of the inline estimated pipe trajectories using ground truth (black) and inline methods (blue) for three methods (i.e., ORBSLAM3 (FIG. 14A), RTABMAP (FIG. 14B), and Ours (FIG. 14C)) and the distance errors to the ground truth. For a thorough quantitative evaluation, ORBSLAM3 may also be included as the baseline. Unlike RTAB-MAP and the new method that rely on pose graph to correct the long-term drifts, ORBSLAM3 may use bundle adjustment for pose optimization which presents the worst result among the three methods. With the support of pose graph optimization module, RTAB-MAP significantly reduces global distance errors, while there are still noticeable errors at the curved and elbow sections (both horizontally and vertically). Compared to the above two methods, the new method imposes the reference constraints into the pose optimization that minimizes the 3D errors between the estimation and the ground truth. Table 4 summarizes the statistics of the distance measurements. The new method reduces the mean distance error from 50 cm and 18 cm as in ORBSLAM3 and RTAB-Map respectively to 4 cm with the standard deviation reduced to approximately 1 cm, which is a substantial improvement. Note that the result is obtained based on the reference points of 2 cm precision, the overall reconstruction accuracy can be further improved if more accurate reference points are available (e.g., total station).

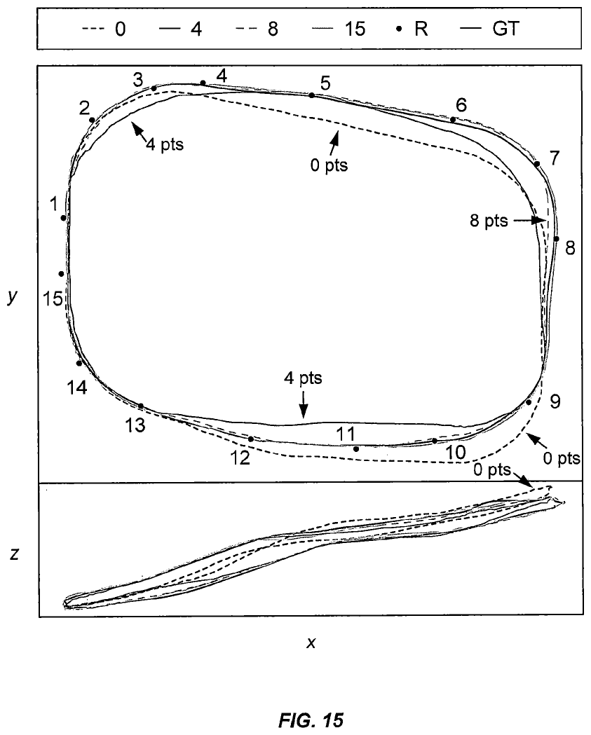

To further assess the effects of the number of reference points on reconstruction accuracy, the pipe trajectories are estimated using different densities of reference points are compared. In this study, the reference points are uniformly resampled into four density levels (i.e., 0, 4, 8, 15). Table 5 compares the RMSEs of the estimated trajectories to the ground truth both in 2D and 3D. The results showed that the 3D RMSE can be reduced from 0.25 meter (m) to 0.04 m when the reference points are densely spread out. Note that as the density of references increases, the rate of accuracy improvement decreases. The comparable results of using 8 and 15 references showed that adding redundant references might result in diminished returns. FIG. 15 shows the horizontal and vertical views of the locations of the reference points, the ground truth pathway of the pipe, and the estimated pipe trajectories with the reference points at different densities. The results showed similar trends as in Table 5 that the estimated trajectories gradually converge to the ground truth as the density of references increases. For the trajectories using eight reference points, relatively large deviations can still be observed at the curved/elbow sections, such as the trajectory next to the references #8, #10, and #12, due to the missed inclusion of these points for pose optimization. The results demonstrate that increasing the density of the references, especially at the curved/elbow sections, is necessary to accurately recover the 3D geometry of the pipe using the vision-based inline reconstruction methods.

FIGS. 14A-14C provide 2D views of the geometric errors (in red) of the pipe trajectories estimated using ground truth (in black) and the inline methods (in blue). (Left—14A) ORBSLAM3; (Middle—14B) RTAB-Map; (Right—14C) Ours. x, y, z units are in meters.

FIG. 4. 2D views of the estimated pipe trajectory under the different number of reference positions (R: reference positions; GT: ground truth model's centerline, IDs, and positions of the reference points are highlighted in x-y dimension).

TABLE 4
Statistic of the distance errors between each
method's estimated pipe's centerline and
the ground truth. Units in meters.

| | | | | | Standard |
|---|---|---|---|---|---|
| | Min | Max | Median | Mean | Deviation |
| | (m) | (m) | (m) | (m) | (m) |
| ORBSLAM3 | 0.022 | 1.239 | 0.422 | 0.498 | 0.326 |
| RTAB-Map | 0.004 | 0.460 | 0.144 | 0.179 | 0.125 |
| Ours | 0.003 | 0.074 | 0.039 | 0.040 | 0.013 |

TABLE 5
The effects of reference positions on the accuracy of
pipe trajectory estimation

| | Selected | Horizontal | Vertical | |
|---|---|---|---|---|
| Number of | Reference | RMSE | RMSE | RMSE |
| References | ID (#) | (m) | (m) | (m) |
| 0 | \ | 0.196 | 0.093 | 0.250 |
| 4 | 1, 5, 9, 13 | 0.157 | 0.053 | 0.164 |
| 8 | 1, 3, 5, 7, 9, 11, 13, 15 | 0.040 | 0.025 | 0.046 |
| 15 | 1-15 | 0.035 | 0.028 | 0.041 |

### 5. Application

Methods and systems disclosed herein have been shown in the laboratory and the field to provide automatic detecting, locating, and mapping defects in a pipeline using inline inspection. Defects that may be detected include pits, dents, deformations, cracks, holes, and such foreign material as debris, water, and the like.

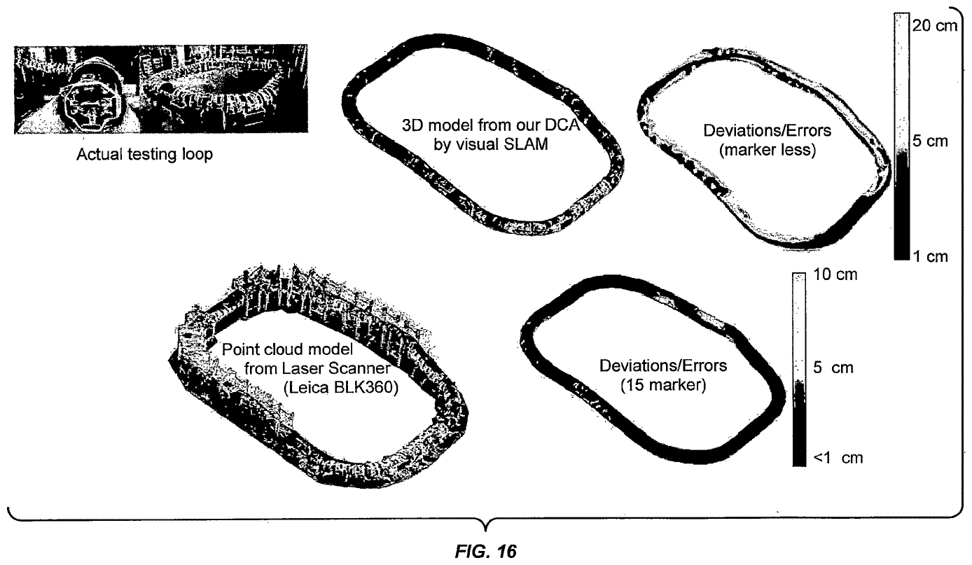

FIG. 16 presents laboratory results of the vSLAM method using both 15 markers and markerless. The data was acquired using an embodiment of the depth camera array discussed above. The ground truth was determined by a point cloud model constructed from a laser scanner (lower right).

The methods and systems of the present disclosure may be deployed in both piggable and non-piggable pipelines. Additionally, the methods and systems may be fast and low-cost. Compared to existing piggable inline inspection, the disclosed rover is small, light, and easier to deply in the field without many logistic constraints.

One or more embodiments of the systems and methods disclosed herein may be employed to detect and map different types of visible defects in many sizes of pipelines. Advantageously, the accuracy of the measurements and mapping may allow pipline operators to quickly locate and assess such defects for informed decision-making. Pipeline operators can run ILI inspections as frequently as needed to monitor the formation process of critical defects.

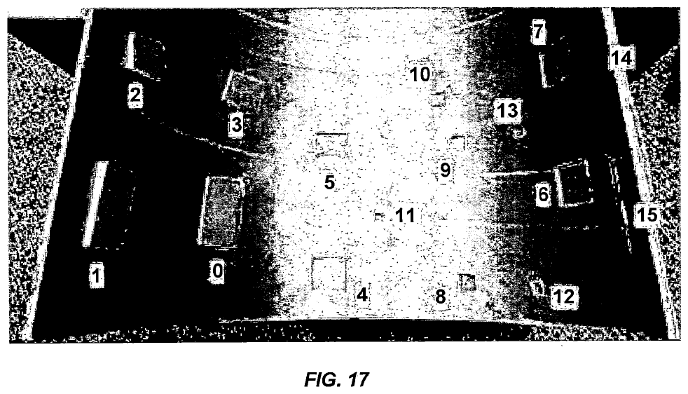

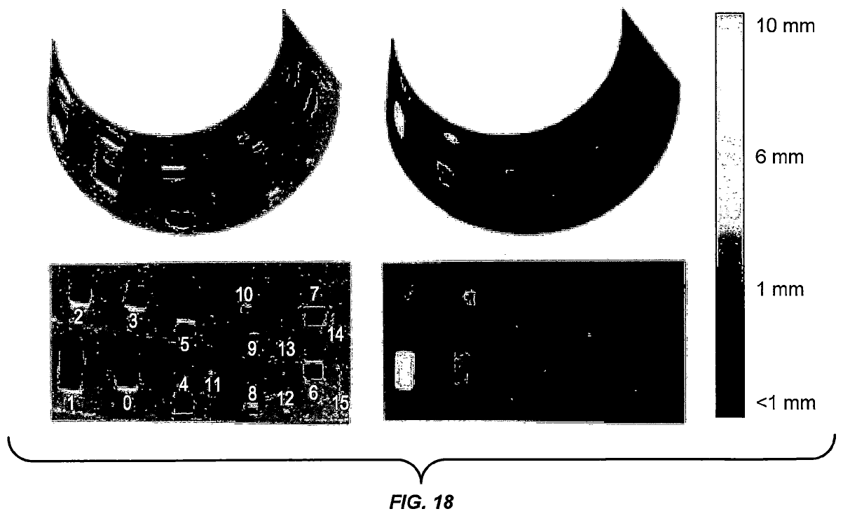

FIG. 17 presents a laboratory pipe wall with artificial pits and dents. Table 6 below provides details of each defect. FIG. 18 provides a comparison of the reconstructed point cloud (ground truth, upper left) and the measurements of the defects (upper right). The lower images show the pipe wall unwrapped.

TABLE 6
Pipe wall defects in laboratory setting

| Defect | | Dimension L, |
|---|---|---|
| ID | Type (Description) | W, D (mm) |
| 0 | Dent (large+, deep) | 72, 36, +4 |
| 1 | Dent (large+, deep+) | 72, 36, +8 |
| 2 | Dent (large, deep+) | 36, 36, +8 |
| 3 | Dent (large, deep) | 36, 36, +4 |
| 4 | Pitting (large, shallow−) | 36, 36, −1 |
| 5 | Pitting (large, deep) | 36, 36, −4 |
| 6 | Pitting (large, medium) | 36, 36, −3 |
| 7 | Pitting (large, shallow) | 36, 36, −2 |
| 8 | Pitting (medium, deep) | 18, 18, −4 |
| 9 | Pitting (medium, medium) | 18, 18, −3 |
| 10 | Pitting (medium, shallow) | 18, 18, −2 |
| 11 | Pitting (small, deep) | 9, 9, −4 |
| 12 | Pitting (small, medium) | 9, 9, −3 |
| 13 | Pitting (small, shallow) | 9, 9, −2 |
| 14 | Crack (narrow) | 7,5, 2, −4 |
| 15 | Crack (wide) | 7.5, 4, −4 |

### 6. Conclusion

In this study, a dual function DCA-based inline inspection system is designed and experimented with for the automated trajectory estimation and surface mapping for inspecting and reconstructing complex underground pipelines. The system generated a dense and complete 3D surface map of pipelines that included a mix of straight and curved sections. The laboratory evaluations showed that the system can reconstruct pipelines with unknown sizes and curvatures while achieving 0.2% distance errors for a 9-foot (2.7-m)-long straight pipe and 4-centimeter geometric accuracy on a 70-foot (21-m)-long pipeline containing complex curved/elbow sections. The study also investigates the modeling performance of using the reference points, and the results showed that references, especially close to the curved/elbowed pipes, are helpful to recover accurate 3D geometry of the pipelines. Real-world natural-gas transmission pipelines include many sections of pipe segments (typically each segment is less than 80 feet (24 m)) that are welded or bolted together. Often the lengths between the joints are known when manufactured and joined in the field. So, these joints can be used as reference points, in addition to other pipeline features such as manifolds. The new method paves the way for reconstructing accurate 3D models of many long-distance and complex old legacy underground utility pipelines of different types of material with little or incomplete information.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Variations may include numerical values, numbers of items, names of instruments and algorithms, and the like. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for reconstruction a three-dimensional (3D) model of a pipeline, the method comprising:
acquiring data using a data acquisition module that controls streaming of red-green-blue-depth (RGBD) images from a forward-view camera and a plurality of oblique cameras, each camera disposed at a front of an inline rover, the forward-view camera facing forward, each oblique camera facing at least partially in a radially inward or radially outward direction toward a surface of the pipeline;
estimating a pipe trajectory using a pipe trajectory estimation module that computes a route of the pipeline based on the RGBD sequence of images from a central camera; and
mapping a pipe surface using a pipe surface mapping module that converts the estimated pipe routes into a complete, dense 3D surface map of the pipeline by incrementally merging the RGBD sequences from the each of the plurality of oblique cameras.

2. The method of claim 1, wherein acquiring data further comprises:
collecting the RGBD sequence of images from each camera at an image resolution at a frame rate; and
synchronizing the images based on a timestamp associated with each image, the synchronizing comprising continuously picking images from a base camera and finding closest images from each other camera in real-time.

3. The method of claim 2, wherein the base camera comprises the forward-view camera and the other cameras comprises the plurality of oblique cameras.

4. The method of claim 1, wherein estimating comprises:
sequentially tracking, using a front-end of the pipe trajectory estimation module, a pose for each camera between images; and
optimizing, using a back-end of the pipe trajectory estimation module, estimated poses using pose graph optimization.

5. The method of claim 4, wherein sequentially tracking comprises:
estimating the pose in a coarse-to-fine fashion by:
employing a feature-based pose estimation to initialize pairwise transformations between adjacent frames and to align images without initialization to create coarsely aligned poses; and
refining the coarsely aligned poses using direct image alignment by maximizing photo consistency measurements from all pixels in the images, and
wherein optimizing estimated poses using pose graph optimization comprises correcting accumulated drift from pairwise measurements including creating a bipartite factor graph with variables and factors as nodes, wherein variables represent poses and factors represent sensor measurements and/or prior knowledge.

6. The method of claim 1, wherein mapping a pipe surface comprises:
recovering a 3D surface map of the pipeline using the synchronized RGBD sequences, recovering comprising using a calibration-free method to directly register each depth camera portion of each RGBD camera by:
separating a whole map of the pipeline into spatially coherent partitions based on selected keyframes;
reconstructing local maps within each partition by aligning RGBD sequences from different cameras; and
fusing the reconstructed local maps between partitions into a global 3D map of the pipeline.

7. The method of claim 1, wherein at least one of the following defects in the pipeline is detected: a dent, a deformation, pitting, a crack, a hole, or foreign material.

8. A system for reconstruction of a three-dimensional (3D) model of a pipeline, the system comprising:
an inline rover configured to transport the system along the pipeline;
a forward-view camera and a plurality of oblique cameras, each camera configured to be disposed on a front of the rover and comprising a red-green-blue (RGB) imaging module and a depth (D) imager that generate an RGBD image, wherein:
the forward-view camera is configured to face forward in an axial direction, and
each oblique camera is configured to face at least partially in a radially inward or radially outward direction toward a surface of the pipeline;
a controller configured to be disposed on the tractor/rover and operatively connected to each camera and configured to control the streaming of each camera and to synchronize the RGBD images of the plurality of cameras, the data acquisition module comprising:
a processor configured to execute instructions of a method that produces a 3D reconstruction of the pipeline;
memory configured to be operably connected to the processor;
a non-transitory computer-readable medium configured to be operably connected to the processor and the memory and to store instructions to be executed by the processor, the instructions comprising the method of any of the preceding claims; and
a source of electrical energy, the source configured to be electrically connected to at least the inline rover, each camera, and the controller.

9. The system of claim 8, wherein the plurality of oblique cameras comprises at least four cameras.

10. The system of claim 8, wherein each camera comprises a depth field of view of the depth imager of at least 75° by at least 45° and an RGB field of view of at least 55° by at least 30°.

11. The system of claim 10, wherein each camera comprises the depth field of view of the depth imager of at least 82° by at least 55° and the RGB field of view of at least 65° by at least 40°.

12. The system of claim 8, wherein the depth imager comprises a first imager, a second imager, and an infrared projector that are spatially separated.

13. The system of claim 12, wherein the first imager, the second imager, and the infrared projector are collinear.

14. The system of claim 8, wherein the plurality of oblique cameras are uniformly spaced around the forward-view camera.

15. The system of claim 8, wherein the forward-view camera is disposed along an axis of the pipeline.
